(19) United States
(12) Patent Application Publication
(10) Pub. No.: US 2005/0062780 A1
(43) Pub. Date: Mar. 24, 2005

(54) Print mechanism utilizing an optical imaging sensor to sense the print medium

(76) Inventor: Chong Hin Chee, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/667,078

(22) Filed: Sep. 18, 2003

(51) Int. Cl. B41J 29/393

(52) U.S. Cl. 347/19; 400/708

(57) ABSTRACT

A print mechanism and method for sensing the print medium are disclosed. The print mechanism includes a print head assembly, actuator, and controller. The print head assembly includes a position detector and a marking device. The position detector includes an imaging device for forming an image of a portion of an edge of a print medium. The actuator moves the print head assembly relative to the print medium in a predetermined direction. The controller determines a location for the edge of the print medium from the formed image. In one embodiment, the controller also determines a brightness value for the print medium from the image and causes the amount of ink deposited by the marking device to be altered. In another embodiment, the controller determines if the print medium is correctly aligned in the print.

### FIELD OF THE INVENTION

The present invention relates to printing systems having movable print heads.

### BACKGROUND OF THE INVENTION

To simplify the following discussion, the present invention will be explained in terms of a typical inkjet printing mechanism; however, it will become apparent from the following discussion that the present invention may be applied to a much wider class of printers. Inkjet printing mechanisms are relatively inexpensive, and hence, inkjet printers are well suited to the personal computer market where capital cost is a key factor in the selection of a printer. In addition, this type of mechanism is employed in very large format printers such as those used to generate architectural drawings and in high-resolution color printers used to create color prints from digital photographs.

Inkjet printers utilize a printing mechanism in which a print head prints a swath of dots as the print head moves across the page in the horizontal direction. The swath typically includes one or more vertical columns of dots. After each swath is printed, the paper is typically advanced in the vertical direction by an amount equal to the height of the swath. The vertical positions of the dots within a swath are determined by the positions of the inkjets in the print head, which are fixed at manufacturing and controlled to a very high degree of accuracy. The horizontal position of each column of drops is controlled by firing the droplet mechanism at times determined by a position feedback device as the print head moves across the paper. The horizontal position is determined by dead reckoning from a fiducial mark on the printing mechanism.

Inexpensive printers, such as inkjet printers, rely on the user to assure that the paper is of the correct size and is correctly positioned in the paper feeding mechanism. The user indicates the desired paper size at the time of printing. However, inexpensive printers do not have any mechanism for verifying that the user placed the proper paper in the printer. If the paper is improperly positioned in the paper feed or becomes mis-positioned due to a mechanical failure, the image will be skewed relative to the edge of the paper. If the paper is the wrong size, the document can run off of the paper.

The image contrast on the paper depends on the brightness of the paper surface. If the document being printed utilizes pages having different brightness levels the contrast from page to page will vary. In general, the print drivers on the computer provide the means for adjusting the ink dispensing mechanism to accommodate different types of papers. However, this mechanism requires a knowledgeable user and is of little value if the paper types vary over the document being printed.

### SUMMARY OF THE INVENTION

The present invention includes a print mechanism and method for printing. The print mechanism includes a print head assembly, an actuator, and a controller. The print head assembly includes a position detector and a marking device. The position detector includes an imaging device for forming an image of a portion of an edge of a print medium. The actuator moves the print head assembly relative to the print medium in a predetermined direction. The controller determines a location for the edge of the print medium from the formed image. In one embodiment, the controller also determines a brightness value for the print medium from the image. The determined brightness value can be utilized to alter the amount of ink deposited by the marking device. In another embodiment, the controller determines if the print medium is correctly aligned in the print mechanism by comparing a plurality of edge locations measured at different distances from the top edge of the print medium.

### BRIEF DESCRIPTION OF THE DRAWINGS

FIG. 1 is a top view of a horizontal print mechanism positioned over a portion of a sheet of paper according to the present invention.

FIG. 2 is a cross-sectional view of the position detector through a line shown in FIG. 1.

### DETAILED DESCRIPTION OF THE PREFERRED EMBODIMENTS OF THE INVENTION

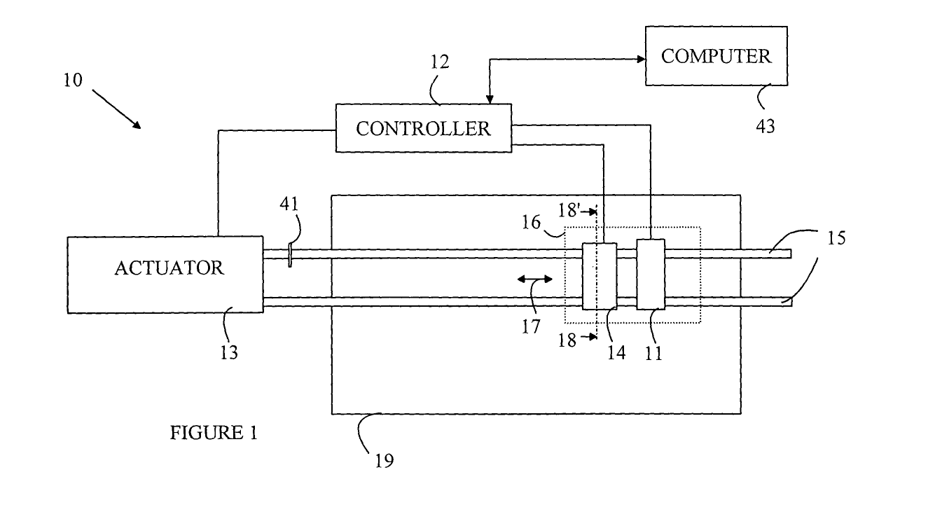

The manner in which the present invention provides its advantages can be more easily understood with reference to FIG. 1, which is a top view of a horizontal print mechanism 10 according to the present invention positioned over a portion of a sheet of paper 19. Mechanism 10 includes a print head assembly 16 that rides on a carriage 15 under the control of an actuator 13 that moves the print bead assembly in the direction shown by arrow 17. Print head assembly 16 includes an ink-dispensing head 11 and a position detector 14.

In inkjet embodiments of the present invention, ink dispensing head 11 includes the inkjet nozzles and the associated circuitry for causing ink-dispensing head 11 to deposit one or more columns of ink drops on paper 19 in response to control signals from controller 12. Since such dispensing heads are known to the art, they will not be discussed in detail here.

The position of ink-dispensing head 11 relative to a fiducial mark 41 is estimated by controller 12. In general, the columns in ink drops are to be aligned with a predetermined grid on the paper. If the motor speed is constant, the position of ink-dispensing head 11 may be computed from the known motor speed and the time since ink-dispensing head 11 passed fiducial mark 41. If there are variations in the motor speed, other mechanisms for determining the position of the print head relative to the fiducial mark 41 can be utilized. For example, a mechanism that utilizes an image sensor for this determination is taught in a co-pending U.S. patent application Ser. No. 10/616,581, filed Jul. 9, 1993, which is hereby incorporated by reference.

Position detector 14 images the surface of paper 19 when the print head is in the vicinity of the paper edges. These images are used to detect the position and alignment of the paper relative to fiducial mark 41 and the horizontal direction defined by the direction of horizontal travel of the print head.

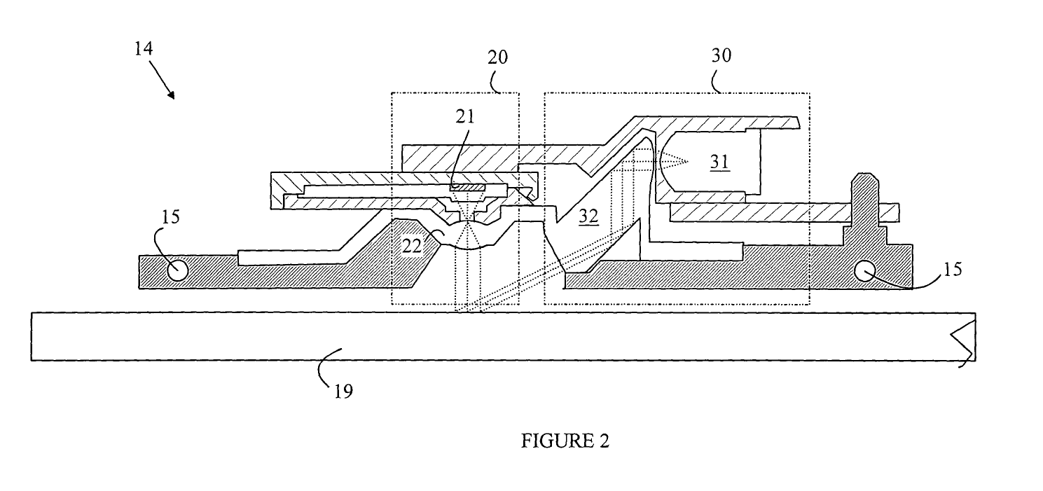

Refer now to FIG. 2, which is a cross-sectional view of position detector 14 through line 18-18′ shown in FIG. 1. Position detector 14 may be viewed as having two principal components, an illumination section 30 and an imaging section 20. Illumination section 30 typically includes an LED light source 31 and an optical assembly 32 that illuminates the surface of the paper 19 with collimated light that strikes the surface at a shallow angle relative to the surface. For example, the angle of the incident light relative to the surface of the paper is less than 45 degrees. Light from the illuminated portion of the surface is imaged by the imaging section onto a sensor 21 with the aid of a lens assembly 22.

The present invention assumes that the portion of the print mechanism exposed next to the edge of the paper has a significantly different reflectivity than that of the paper. For example, the paper is fed over a roller in some inkjet printers, and hence, the position detector views the surface of the roller in those regions of the roller that are not covered by the paper. For the purpose of the present discussion, it will be assumed that the area next to the paper is substantially darker than the paper. The image generated by the position detector is preferably a plurality of pixel values organized as a plurality of rows that run in the direction of travel of the print head. Hence, each horizontal line in the image in the vicinity of the edge of the paper will be a “step” function that is white over the paper and dark over the print carriage. Algorithms for detecting the point at which the image transitions between a dark and a light region are known to the art, and hence, will not be discussed in detail here. For the purposes of the present discussion, it is sufficient to note that a threshold can be defined that distinguishes the paper from the underlying paper carriage mechanism. Portions of the image having a brightness greater than this threshold are assumed to be over the paper, and portions of the image having a brightness less than or equal to this threshold are assumed to be over the print carriage.

If the current image shows a transition from dark to light, then the position detector is over the left edge of the paper. The exact position of the edge can be estimated by determining the last point at which the image is below the threshold. Similarly, if the position detector is over the right edge of the paper, the image will transition from light to dark.

The position detector can also be used to detect the position of the top and bottom edges of the paper. When the position detector is positioned over the top edge, the rows of pixels that are over the paper will show the transition between dark and light regions within the row. The rows over the print carriage will not show such a transition. Hence, by determining the first row that shows the dark to light transition, the position of the top or bottom edge of the paper can be determined. The alignment of the paper in the carriage is determined by examining the position of one of the vertical edges as a function of the vertical distance between the top edge of the paper. If the paper is mis-aligned, the edge position will vary with the vertical distance from the top of the paper.

The size of the paper can be readily ascertained by using the measured positions of the edges. For example, the horizontal and vertical position of the image sensor can be determined by dead reckoning from the top edge of the paper and the left edge of the paper. The vertical distance can be computed from the number of horizontal swaths of pixels that have been printed. The horizontal distance can be determined by the time that has elapsed since fiducial 41 was detected.

The size of the paper is preferably reported by the controller to the print driver on the computer from which the printer is controlled, as this minimizes the cost of the hardware that must be included in the printer. However, embodiments in which the print driver sends information specifying the desired paper size to the controller can also be practiced. In such an embodiment, the controller would notify the user of the incorrect paper size.

The above-described embodiments of the present invention have utilized a print head assembly in which position detector 14 is separate from the ink-dispensing head 11. However, embodiments in which the position detector is part of the ink-dispensing head can also be practiced. The preferred embodiment utilizes separate assemblies, since the ink-dispensing head is disposable, and hence, the cost of the printer is reduced by utilizing separate assemblies, since the position detector has a lifetime that is many times that of an ink-cartridge. However, it should be noted that ink-dispensing heads that include imaging sensors have been proposed to provide feedback to the ink-dispensing system. In such a system, the present invention could, in principle, utilize the ink-dispensing head imaging sensor if that imaging sensor has sufficient resolution.

The above-described embodiments of the present invention have utilized ink-jet printers. However, the present invention can be implemented on any printing device having a similar mechanism in which a marking device is moved over the print medium. For example, some thermal printers also utilize a print head assembly that moves across the paper on an actuator driven carriage in which dots are printed on the paper by timing the firing of a heat source in the print head assembly. Similarly, impact printers in which a hammer is triggered to generate dots or formed characters often utilize print head assemblies that move across the page.

The contrast observed by the position detector can also be used to measure the brightness of the paper. The observed intensity in the bright region of the image provides a measure of the paper brightness. If the reflectivity of the portion of the paper carriage adjacent to the paper is known, an absolute measure of the paper brightness can be made. This information is preferably communicated to the print driver in the host computer 43. The print driver can then vary the amount of ink dispensed in response to changes in brightness. This allows the ink dispensed per dot to be automatically adjusted when the paper stock is changed.

The above-described embodiments of the present invention utilize a two-dimensional image sensor in the position detector. The two-dimensional image sensor described above is preferred since such sensors are mass-produced for use in optical mouse pointing devices, and hence, are available at a cost that is compatible with low cost inkjet printers. However, embodiments that utilize one-dimensional sensors can also be practiced. The detection of the vertical edges of the paper can be accomplished with a one-dimensional image sensor comprising a single row from the image sensor described above. Similarly, the detection of the top and bottom edges of the paper can be accomplished with a one-dimensional image sensor comprising a single column from the image sensor described above.

Various modifications to the present invention will become apparent to those skilled in the art from the foregoing description and accompanying drawings. Accordingly, the present invention is to be limited solely by the scope of the following claims.

1. A print mechanism comprising:
a print head assembly comprising a position detector and a marking device, said position detector comprising an imaging device for forming an image of a portion of an edge of a print medium, said print medium having a top edge, side edges, and a bottom edge;
an actuator for moving said print head assembly relative to said print medium in a predetermined direction; and
a controller for determining a location for said edge of said print medium from said formed image.

2. The print mechanism of claim 1 wherein said controller determines a brightness value for said print medium from said image.

3. The print mechanism of claim 1 wherein said controller determines a location for said top edge of said print medium from said image.

4. The print mechanism of claim 1 wherein said controller determines if said print medium is correctly aligned in said print mechanism by comparing a plurality of edge locations measured at different distances from said top edge of said print medium.

5. A method for printing on a print medium having a top edge and side edges, said method comprising:
forming an image of a portion of an edge of said print medium; and
determining a location for said imaged edge of said print medium from said image.

6. The method of claim 5 wherein said imaged edge is one of said side edges.

7. The method of claim 5 wherein said imaged edge is said top edge.

8. The method of claim 5 further comprising determining a brightness measure for said print medium.

9. The method of claim 5 further comprising determining the alignment of said print medium in a print mechanism by comparing a plurality of images of portions of said edge of said print medium.

10. The method of claim 5 further comprising determining the dimensions of said print medium from a plurality of images of portions of said edge.
